(19) United States
(12) Patent Application Publication
(10) Pub. No.: US 2018/0136842 A1
(43) Pub. Date: May 17, 2018

(54) PARTITION METADATA FOR DISTRIBUTED DATA OBJECTS

(71) Applicant: Hewlett Packard Enterprise Development LP, Houston, TX (US)

(72) Inventors: Mijung Kim, Palo Alto, CA (US); Jun Li, Palo Alto, CA (US); Yuan Chen, Palo Alto, CA (US)

(21) Appl. No.: 15/349,427

(22) Filed: Nov. 11, 2016

(51) Int. Cl. G06F 3/06

(52) U.S. Cl. CPC G06F 3/064; G06F 3/0604; G06F 3/0679; G06F 3/0659; G06F 3/0644

(57) ABSTRACT

In some examples, a system includes a shared memory, a metadata store separate from the shared memory, and a management engine. The management engine may receive input data, partition the input data into multiple data partitions to cache the input data in the shared memory as a distributed data object, send partition store instructions to store the multiple data partitions within the shared memory. The management engine may also obtain partition metadata for the multiple data partitions that form the distributed data object. The partition metadata may include global memory addresses within the shared memory for the multiple data partitions. The management engine may further store the partition metadata in the metadata store.

### BACKGROUND

With rapid advances in technology, computing systems are increasingly prevalent in society today. Vast computing systems execute and support applications that communicate and process immense amounts of data, many times with performance constraints to meet the increasing demands of users. Increasing the efficiency, speed, and effectiveness of computing systems will further improve user experience.

### BRIEF DESCRIPTION OF THE DRAWINGS

Certain examples are described in the following detailed description and in reference to the drawings.

FIG. 1 shows an example of a system that supports use of partition metadata for distributed data objects.

FIG. 2 shows an example of a system that supports storage of partition metadata for distributed data objects cached in a shared memory.

FIG. 3 shows examples of partition metadata that a metadata store may persist for distributed data objects.

FIG. 4 shows an example of a system that supports retrieval of data partitions from a shared memory using partition metadata.

FIG. 5 shows an example of a system that supports node-based task scheduling using partition metadata.

FIG. 6 shows a flow chart of an example method to use partition metadata for a distributed data object.

FIG. 7 shows an example of a system that supports scheduling tasks for execution using partition metadata for a distributed data object.

### DETAILED DESCRIPTION

The discussion below refers to a shared memory. A shared memory may refer to a memory medium accessible by multiple different processing entities. In that regard, a shared memory may provide a shared storage medium for any number of devices, nodes, servers, application processes and threads, or various other physical or logical processing entities. Data objects cached in a shared memory may be commonly accessible to different processing entities, which may allow for increased parallelism and efficiency in data processing. In some examples, the shared memory may implement an off-heap memory store which may be free from the garbage collection overhead and constraints of on-heap caching (e.g., via a Java heap) as well as the latency burdens of local disk caching.

Examples consistent with the present disclosure may support creating, persisting, and using partition metadata to support access to distributed data objects stored in a shared memory. A distributed data object may refer to a data object that is stored in separate, distinct memory regions of a shared memory. In that regard, the distributed data object may be split into multiple data partitions, each stored in a different portion of the shared memory. In effect, the multiple data partitions may together form the distributed data object. As described in greater detail below, partition metadata may be persisted for each of the multiple data partitions that form a distributed data object. Subsequent access to the distributed data object by processing nodes, application threads, or other executional logic may be possible through referencing persisted partition metadata.

Persisted partition metadata may also support shared access to a distributed data object across different processing stages in a single process as well as across multiple processes. Subsequent processes may directly access the distributed data object in the shared memory using persisted partition metadata, this is in contrast to other costly alternatives such as caching through distributed in-memory file systems that rely on TCP/IP-based remote data fetching or reloading the distributed data object into virtual machine caches on a per-process basis. As such, the partition metadata features described herein may increase the speed and efficiency at which data is accessed and processed in shared memory systems.

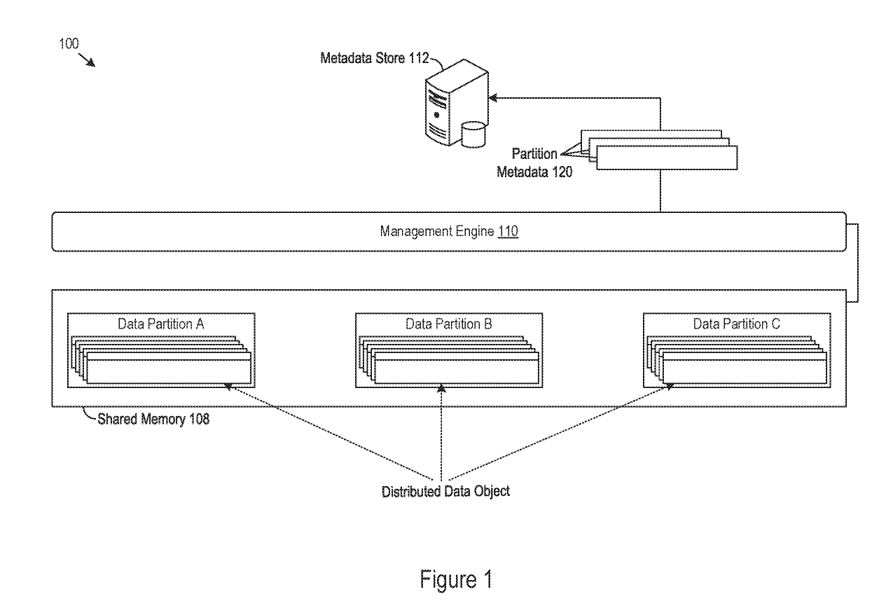

FIG. 1 shows an example of a system 100 that supports use of partition metadata for distributed data objects. The system 100 may take the form of any computing system that includes a single or multiple computing devices such as servers, compute nodes, desktop or laptop computers, smart phones or other mobile devices, tablet devices, embedded controllers, and more. As described in greater detail herein, the system 100 may access and use partition metadata for distributed data objects. A distributed data object may be represented and stored as multiple different data chunks, portions, or segments, referred herein as data partitions. Partition metadata may refer to any data indicative of how data partitions (e.g., that form a distributed data object) are stored in a shared memory. Through partition metadata, the system 100 may provide a mechanism to store and retrieve data partitions of a distributed data object cached in a shared memory. Different application processes may reuse the same data partitions, and may do so without having to locally load the data partitions repeatedly for each separate process, thread, job, or task executed by an application.

The system 100 may include various elements to provide or support any of the partition metadata features described herein. In the example shown in FIG. 1, the system 100 includes a shared memory 108, a management engine 110, and a metadata store 114. As noted above, the shared memory 108 may provide a shared memory medium accessible to different processing entities. The shared memory 108 may be implemented as a non-volatile memory (NVM), for example through non-volatile random access memory (NVRAM), flash memory, memristor arrays, solid state drives, and the like. In some examples, the shared memory 108 additionally or alternatively include volatile memory. The shared memory 108 may be byte-addressable or block addressable, and may utilize a global addressing scheme for accessing the various regions of the shared memory 108. In some examples, the shared memory 108 includes physically separate memory devices interconnected by a high-speed memory fabric.

The shared memory 108 may store (e.g., cache) distributed data objects stored as multiple data partitions. In some implementations, the shared memory 108 provides an off-heap data store to cache distributed data objects accessible by multiple application processes and threads. Example features for using a shared memory as an off-heap store to cache distributed data objects are described in International Application No. PCT/US2015/061977 titled “Shared Memory for Distributed Data” filed on Nov. 20, 2015, which is hereby incorporated by reference it its entirety.

The system 100 may include a management engine 110 to manage the creation, persistence, and usage of partition metadata for data partitions stored in the shared memory 108. In the example shown in FIG. 1, the management engine 110 may obtain partition metadata 120 for a distributed data object stored as data partitions A, B, and C. In that regard, the partition metadata 120 may describe characteristics of how the data partitions A, B, and C of FIG. 1 are respectively stored in the shared memory 108. Example elements of partition metadata 120 may include global memory addresses for each of the data partitions, node identifiers specifying memory regions or devices where the data partitions are stored, and more. The management engine 110 may persist the partition metadata 120 by storing the partition metadata 120 in the metadata store 112, which may be implemented as a distributed file system (e.g., an HDFS), a relational database, or according to any other data storage mechanism.

The system 100 may implement the management engine 110 (including components thereof) in various ways, for example as hardware and programming. The programming for the management engine 110 may take the form of processor-executable instructions stored on a non-transitory machine-readable storage medium, and the processor-executable instructions may, upon execution, cause hardware to perform any of the features described herein. In that regard, various programming instructions of the management engine 110 may implement engine components to support or provide the features described herein.

The hardware for the management engine 110 may include a processing resource to execute programming instructions. A processing resource may include various number of processors with a single or multiple processing cores, and a processing resource may be implemented through a single-processor or multi-processor architecture. In some examples, the system 100 implements multiple engines (or other logic) using the same system features or hardware components, e.g., a common processing resource).

In some examples, the management engine 110 may receive input data and partition the input data into multiple data partitions to cache the input data in the shared memory 108 as a distributed data object. To support caching of the data partitions in the shared memory 108, the management engine 110 may send partition store instructions to store the multiple data partitions within the shared memory. Then, the management engine 110 may obtain partition metadata 120 for the multiple data partitions that form the distributed data object, and the partition metadata may include global memory addresses within the shared memory 108 for the multiple data partitions. The management engine 110 may further store the partition metadata 120 in the metadata store 112.

These and other aspects of partition metadata features disclosed herein are described in greater detail next.

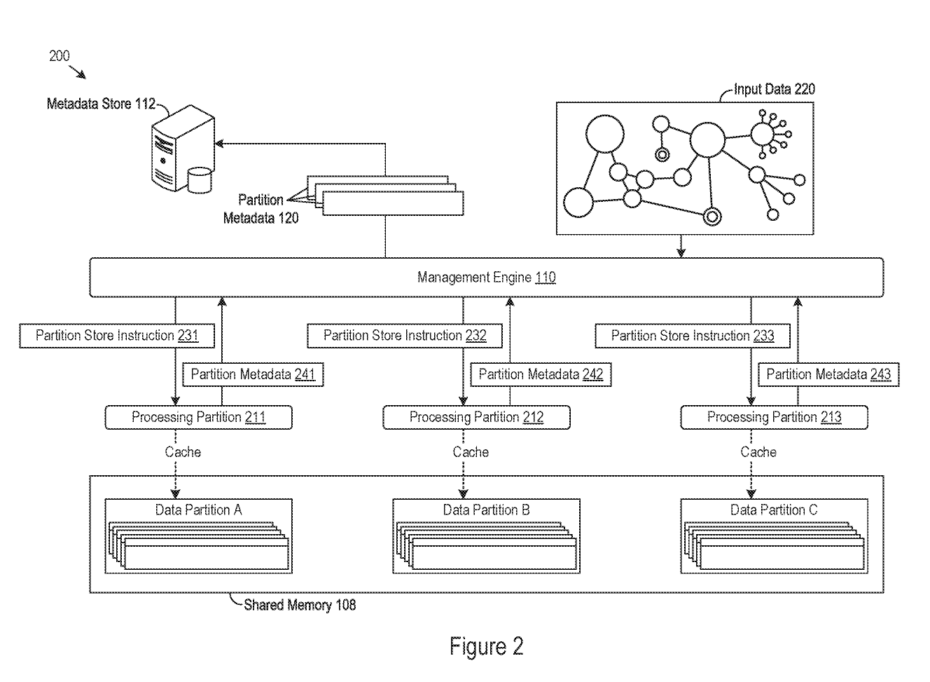

FIG. 2 shows an example of a system 200 that supports storage of partition metadata for distributed data objects cached in a shared memory. The example system 200 shown in FIG. 2 includes a shared memory 108, management engine 110, metadata store 112 and multiple processing partitions. A processing partition may refer to any distinct unit of logic that can perform an action. Example processing partitions may include compute nodes, processing components of a distributed system, CPUs or processors, application threads (and underlying hardware, which may be shared by multiple processing partitions), and much more. In FIG. 2, three processing partitions are depicted as processing partitions 211, 212, and 213. However, the system 200 may include any number of processing partitions, and multiple processing partitions may be used for parallel processing of distributed data objects. In some implementations, the management engine 110 may implement or execute a driver program of a cluster computing framework (e.g., Apache Spark) and the processing partitions 211, 212, and 213 may implement executor threads of the cluster computing framework.

In operation, the management engine 110 may receive input data and cache the input data in the shared memory 112 as a distributed data object. In the example shown in FIG. 2, the management engine 110 receives input data 220 in the form of a graph, though any other type or form of input data may be similarly received. The management engine 110 may split the input data 220 into multiple data partitions, and each data partition may store a portion of the input data 220. In FIG. 2, the management engine 110 splits the input data 220 into three data partitions illustrated as data partition A, B, and C. To cache the multiple data partitions formed from the input data 220, the management engine 110 may utilize the processing partitions 211, 212, and 213. In particular, the management engine 110 may send partition store instructions to each processing partition to store a respective data partition of the input data 220 in the shared memory 108.

In FIG. 2, the management engine 110 sends a partition store instruction 231 to the processing partition 211, a partition store instruction 232 to the processing partition 212, and a partition store instruction 233 to the processing partition 213. A partition store instruction issued by the management engine 110 may include a data partition of the input data 220 to store in the shared memory 108. To illustrate through FIG. 2, the partition store instruction 231 issued to the processing partition 211 may include data partition A of the input data 220, partition store instruction 232 may include data partition B of the input data 220, and so on. Responsive to receiving a respective partition store instruction, the processing partitions 211, 212, and 213 may cache the data partitions A, B, and C in a respective portion of the shared memory 108. In that regard, the processing partitions 211, 212, and 213 may allocate a specific portion of shared memory 108 (e.g., address range) to store the data partitions A, B, and C.

In some examples, a processing partition is associated with a specific region of the shared memory 108. For instance, the shared memory 108 may be formed as multiple physical memory devices linked through a high-speed memory fabric, and a specific processing partition may be physically or logically co-located with a particular memory device (e.g., physically on the same computing device or grouped within a common computing node). By distributing the data partitions to different processing partitions, the management engine 110 may, in effect, represent the input data 220 as a distributed data object stored in different memory regions of the shared memory 108. Subsequent access to these distributed portions of the input data 220 may be accomplished by referencing partition metadata, which the processing partitions 211, 212, and 213 may create and provide to the management engine 110.

In particular, a processing partition that caches a data partition may generate corresponding partition metadata for the cached data partition. The processing partition 211, for example, may cache data partition A split from the input data 220 and generate the partition metadata applicable to data partition A. As the processing partition 211 is involved in storing data partition A, the processing partition 211 may be operable to identify the characteristics as to how data partition A is stored and determine to include such characteristics as elements of generated partition metadata. As such, the processing partition 211 may create or generate the partition metadata for data partition A. Some example elements of partition metadata that processing partitions may generate and the management engine 110 may persist are provided next.

Partition metadata may include a global memory address for a data partition, which may include any information pointing to a specific portion of the shared memory 108. In some examples, a global memory address element of partition metadata may include a global memory pointer that points to the memory region, block, or address in the shared memory 108 at which storage of the data partition begins. An example representation of a global memory pointer is a value pair identifying a memory region and a corresponding offset, e.g., a <region ID, offset> value pair, each of which may be represented as unsigned integers. Global memory pointers may be converted to local memory pointers (e.g., within a specific memory device part of the shared memory 108) to access and manipulate a data partition. If a data partition is represented as multiple data structures as described in International Application No. PCT/US2015/061977 (e.g., as both a hash table and a sorted array), the global memory address may include multiple global memory pointers for multiple data structures.

As another example element, partition metadata may include node identifiers. A node identifier may indicate a specific computing element that the data partition is stored on. Various granularities of computing elements may be specified through the node identifier, e.g., providing distinction between physical computing devices, logical nodes or elements, or combinations thereof. As illustrative examples, the node identifier may indicate a particular memory or computing device that the data partition is stored on or a particular non-uniform memory access (NUMA) node within a device that the data partition is stored on. For multi-machine systems, the node identifier may specify both a machine identifier as well as a NUMA node identifier applicable to the specific machine. Node identifiers stored as partition metadata may allow the management engine 110 to adaptively and intelligently schedule tasks to leverage data locality, as described in greater detail below.

While some examples of partition metadata elements have been described, the processing partitions may identify any other characteristic or information indicative of how data partitions are cached in the shared memory 108. The specific partition metadata elements identified by the processing partitions to include in generated partition metadata may be configured or controlled by the management engine 110. For instance, the management engine 110 may instruct processing partitions as to the specific partition metadata elements to obtain through an issued partition store instruction or through a separate communication or instruction.

The processing partitions may provide generated partition metadata to the management engine 110, which the management engine 110 may persist to support subsequent access to cached data partitions of a distributed data object. In that regard, the management engine 110 may collect or otherwise obtain generated partition metadata from various processing partitions that cached data partitions of a distributed data object. In FIG. 2, the processing partition 211 generates the partition metadata 241 specific to data partition A and sends the partition metadata 241 to the management engine 110. In a similar manner, the management engine 110 may receive the partition metadata 242 for data partition B and the partition metadata 243 for data partition C. The partition metadata 241, 242, and 243 may be part of the partition metadata 120, which the management engine 110 stores in the metadata store 112.

In some implementations, the management engine 110 may broadcast received partition metadata. In particular, the management engine 110 may send partition metadata generated by a particular processing partition to other processing partitions (e.g., some or all other processing partitions). By doing so, the management engine 110 may ensure multiple processing partitions can identify, retrieve, or otherwise access a particular data partition of a distributed data object for subsequent processing. To provide an illustration through FIG. 2, the management engine 110 may broadcast the partition metadata 241 collected by the processing partition 211 for data partition A to processing partitions 212 and 213 (e.g., processing partitions that did not cache data partition A and did not collect the partition metadata 241 during the caching process). In a similar manner, the management engine 110 may broadcast the partition metadata 242 and 243 to other processing partitions. Each processing partition may obtain the partition metadata for each data partition cached for a distributed data object, and may thus be able to perform an action, task or other processing job on any of the various data partitions that form the distributed data object.

As described above, partition metadata may be collected and stored to support access to the multiple data partitions that form a distributed data object.

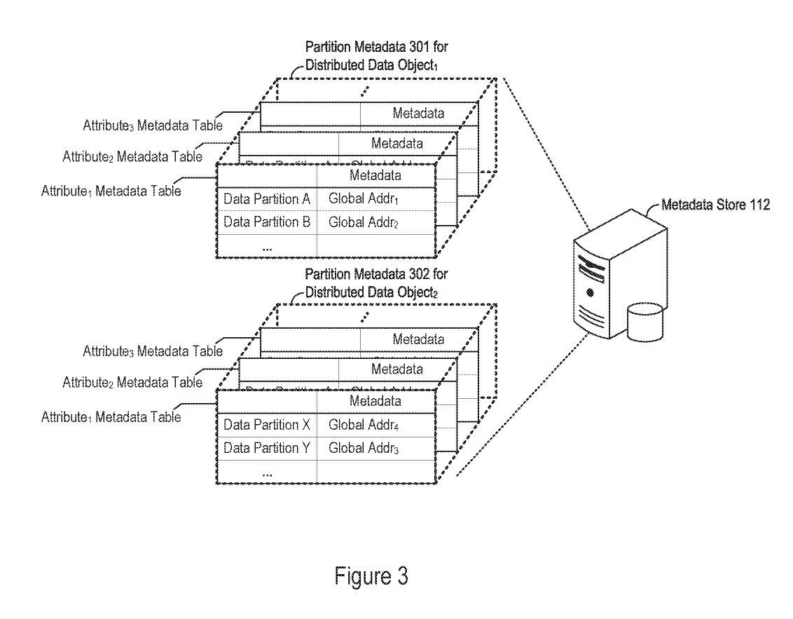

FIG. 3 shows examples of partition metadata that a metadata store may persist for distributed data objects. In the example shown in FIG. 3, a metadata store 112 stores partition metadata for two different data objects, labeled as partition metadata 301 and 302.

Partition metadata may be structured, collected, or stored in a preconfigured format, which the management engine 110 may specify (e.g., according to user input). Partition metadata may be segregated according to distributed data objects, and the processing partitions or management engine 110 may associate collected partition metadata with a particular distributed data object (e.g., by a data object identifier or name, such as input_graph_A or any other object ID or identifier).

In some examples, the management engine 110 receives and stores partition metadata that includes attribute metadata tables. Attributes may refer to components of a data object, and attribute metadata tables may store the specific partition metadata for data partitions associated with particular attributes, e.g., data partitions storing attribute values for a particular attribute of a distributed data object. Partition metadata for a data object may include an attribute metadata table for each attribute of the data object. Attribute metadata tables may further identify each data partition that stores attribute values for a particular attribute, e.g., through table entries as data partition-partition metadata pairs as shown in FIG. 3.

As an illustrative example, a graph data object may include various attributes such as a node attribute, an edge attribute, an edge constraint attribute, and more. Object data for the graph data object may be stored as attribute values of the various node, edge, edge constraint, or other attributes. To store partition metadata for the graph data object, a node attribute metadata table in the metadata store 112 may store partition metadata for the specific data partitions cached in the shared memory storing node values of the graph data object. An edge attribute metadata table may store partition metadata for the specific data partitions cached in the shared memory storing edge values of the graph data object, and so on.

In FIG. 3, the partition metadata 301 and 302 each include attribute metadata tables for attribute₁, attribute₂, and attribute₃ of the distributed data objects. The attribute metadata tables include partition metadata for the specific data partitions storing corresponding attribute values. Put another way, each particular attribute metadata table may include global memory addresses for the particular data partitions storing object data for a specific attribute of the distributed data object. To further illustrate through FIG. 3 in which distributed data object₁ is characterized by the partition metadata 301, data object values for attribute₁ of the data object are stored at data partition A with a starting global memory address of “Global Addr₁”, data partition B with a starting global memory address of “Global Addr₂”, and so forth.

As the partition metadata stored in a metadata store 112 may be divided according to attributes of a distributed data object, subsequent access and processing of the distributed data object may be accomplished on a per-attribute basis. The management engine 110 and processing partitions may use partition metadata to specifically access data partitions for a particular attribute of a distributed data object. Such per-attribute access may, for example, support parallel retrieval and processing of node values or edge values of a graph data object. Application processes, execution threads, and other processing logic may access any attribute of a distributed data object for jobs and processing through attribute metadata tables of partition metadata for a distributed data object.

While some examples of how partition metadata may be stored are presented in FIG. 3, various other formats are possible. The processing partitions and management engine 110 may obtain partition metadata according to any of the various partition metadata formats described herein. The management engine 110 and processing partitions may subsequently retrieve data partitions using partition metadata stored in the metadata store 112.

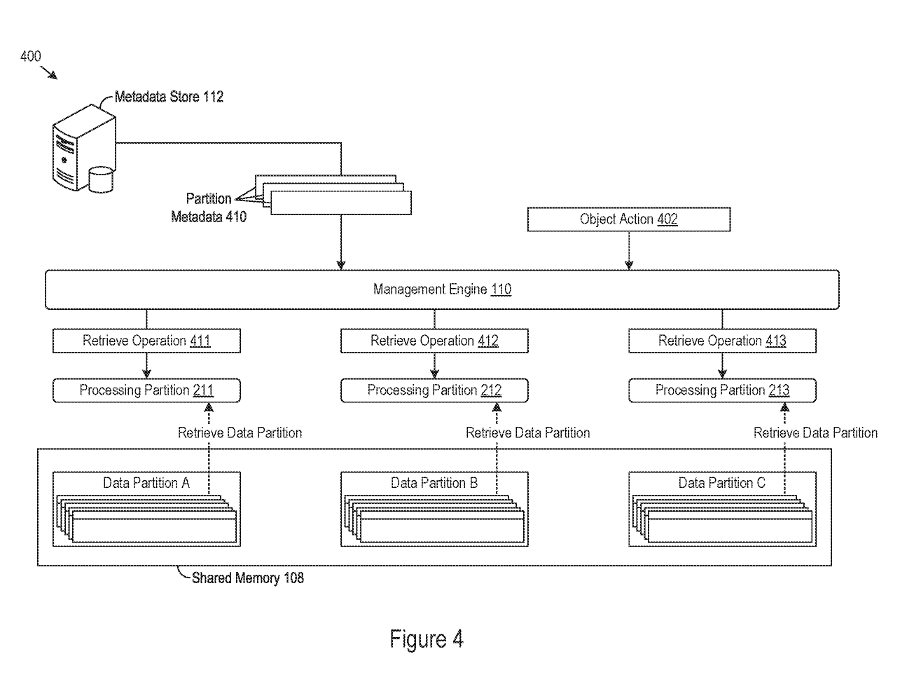

FIG. 4 shows an example of a system 400 that supports retrieval of data partitions from a shared memory using partition metadata. The system 400 in FIG. 4 includes a shared memory 108, management engine 110, metadata store 112, and processing partitions 211, 212, and 213.

In operation, the management engine 110 may identify an object action to perform on a distributed data object (or portion thereof). The object action may be user-specified, for example. In such cases, the management engine 110 may receive an object action 402 from external entity. In other examples, objects actions to perform on a distributed data object may be implemented by the management engine 110 itself, for example through execution of a driver program of a cluster computing platform or in other contexts. The object action may be any type of processing, action, transformation, analytical routine, job, task, or any other unit of work to perform on a distributed data object.

To perform an object action on a distributed data object cached in the shared memory 108, the management engine 110 may identify the data partitions of the distributed data object that the object action applies to. The object action may apply to specific attributes of the distributed data object, in which case the management engine 110 may access partition metadata for the distributed data object with respect to the applicable attributes. Such an access may include retrieving the specific attribute metadata tables of the applicable attributes from the metadata store 112, e.g., a node attribute metadata table and an edge attribute metadata table for a graph transformation action on a particular graph data object. In FIG. 4, the management engine 110 may load partition metadata 410 for the multiple data partitions upon which the object action 402 operates.

The management engine 110 may support retrieval of data partitions on which to execute the object action 402 through the loaded partition metadata 410. The loaded partition metadata 410 may specify, as examples, the global memory addresses in the shared memory 108 at which the applicable data partitions are located. Accordingly, the management engine 110 may instruct the processing partitions 211, 212, and 213 to retrieve the data partitions A, B, and C (for example) to perform the object action 402. In FIG. 4, the management engine 110 sends the retrieve operations 411, 412, and 413 to the processing partitions 211, 212, and 213 respectively.

The object action 402 may be part of a process or job subsequent to the process or job (e.g., execution threads) launched to cache the distributed data object as data partitions. Nonetheless, the management engine 110 may support subsequent access to the cached data partitions through persisted partition metadata. To retrieve data partitions applicable to the object action 402, the management engine 110 may pass each processing partition a parallel data processing operation to effectuate the object action 402. The parallel data processing operation may cause processing partitions to operate in parallel to perform the object action 402 on retrieved data partitions. In such cases, the management engine 110 may issue the retrieval operations 411, 412, and 413 in parallel, and each retrieval operation may include partition metadata specific to a particular data partition that a processing partition is to operate on. Thus, the processing partitions 211, 212, and 213 may retrieve corresponding data partitions and perform the object action 402 in parallel.

In some implementations, the management engine 110 may assign jobs, tasks, or other units of work to a particular processing partition based on partition metadata. The partition metadata may allow the management engine 110 to, for example, leverage data locality and intelligently schedule tasks for execution. Some example scheduling features using partition metadata are described next.

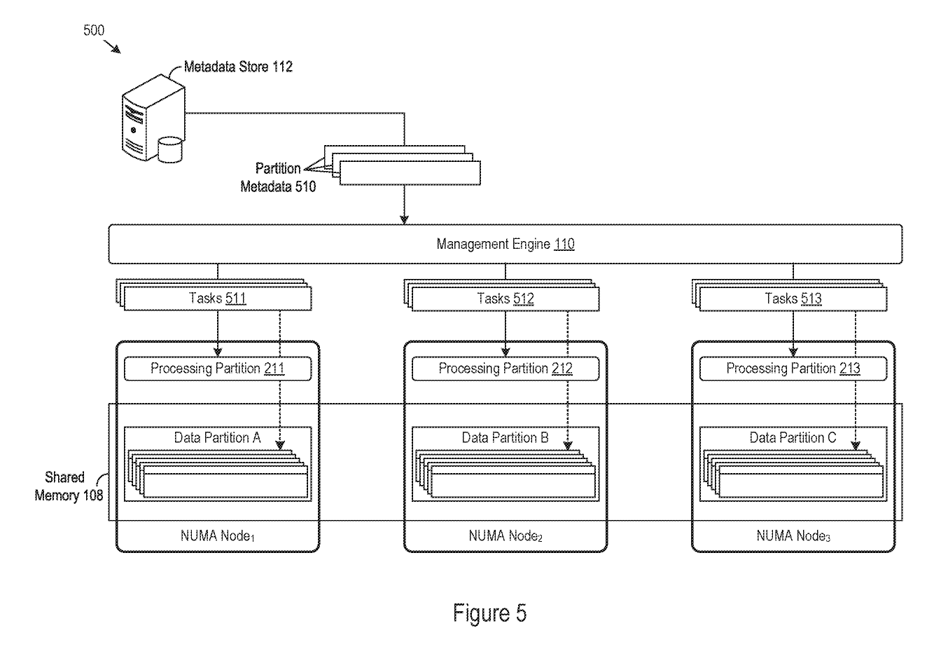

FIG. 5 shows an example of a system 500 that supports node-based task scheduling using partition metadata. The system shown in FIG. 5 includes a shared memory 108, management engine 110, metadata store 112, and processing partitions 211, 212, and 213. The processing partitions 211, 212, and 213 as well as various memory regions of the shared memory 108 may be located on separate nodes, which may refer to any physical or logical separation between computing or storage entities. As noted above, partition metadata for a distributed data object may indicate a specific physical device that a data partition is stored on (e.g., a memory device of a particular server) and/or a node divided within a physical device that the data partition is stored on (e.g., a particular NUMA node among a set of NUMA nodes in a server).

In the example shown in FIG. 5, the shared memory 108 is formed from memory regions of different NUMA nodes, shown as NUMA node₁, NUMA node₂, and NUMA node₃. A NUMA node may include memory and at least one processor, and a single computing device may include multiple NUMA nodes. The NUMA nodes in FIG. 5 may include processors via the processing partitions, with processing partition 211 being part of NUMA node₁, processing partition 212 being part of NUMA node₂, and processing partition 213 being part of NUMA node₃. Partition metadata for distributed data objects cached in the shared memory 108 may specify a particular NUMA node that data partitions are stored on.

Through partition metadata that includes node identifiers (e.g., NUMA node ID values), the management engine 110 may schedule tasks for execution on processing partitions to account for data locality. Data locality can have a significant impact on performance, and assigning a task for execution by a processing partition co-located with stored data partitions may improve the efficiency and speed at which data operations are performed. In such cases, a processing partition may retrieve a data partition to perform a task upon on via a local memory access instead of a remote memory access (e.g., to a memory region of the shared memory 108 implemented on a different physical device, accessible through a high-speed memory fabric). Some of the illustrations provided next with respect to FIG. 5 relate to NUMA-aware scheduling, though other scheduling mechanisms may be consistently applied by the management engine 110 for node identifiers of any other granularity.

In FIG. 5, the management engine 110 may retrieve partition metadata 510 for a distributed data object cached on the shared memory 112 as multiple data partitions A, B, and C. Based on the partition metadata 510, the management engine 110 may schedule and assign tasks for execution by the processing partitions 211, 212, and 213, taking into account the particular NUMA node that the data partitions A, B, and C are stored upon. A tasks may refer to any unit of work to perform, e.g., as part of an object action, process, thread, or job. The task may operate on specific portion of a distributed data object, and the management engine 110 may identify the particular data partition(s) that tasks apply to. For each identified data partition, the management engine 110 may determine a NUMA node that the identified data partition is stored on, and schedule tasks to perform on the identified data partition accounting for the determined NUMA node that stores the identified data partition.

In FIG. 5, the management engine 110 schedules the tasks 511 for execution by the processing partition 211, the tasks 512 for execution by the processing partition 212, and the tasks 513 for execution by the processing partition 213. Scheduling a task may include forwarding the task to a selected processing partition, sending a task initiation instruction to the selected processing partition, or otherwise causing the processing partition to perform the task.

To explain various node-based scheduling features, illustrations are provided with respect to the management engine 110 scheduling tasks for execution that operate on data partition A stored on NUMA node, of FIG. 5. The management engine 110 may identify a task that operates on data partition A and determine, through the partition metadata 510, that data partition A is stored on NUMA node₁. In some examples, the management engine 110 schedules the task for immediate execution by the processing partition 211, e.g., the processing partition physically or logically co-located with the portion of the shared memory 108 storing data partition A. Scheduling a task for immediate execution may refer to taking action to start execution of the task without injecting an intentional delay, though “immediate” execution may include any latency for transmitting the task to the processing partition 211, retrieving data partition A from the shared memory 108, instantiating the processing partition 211 itself to execute the task, or any other latency incurred through normal operation.

In some examples, the management engine 110 schedules the task that operates on data partition A for immediate execution by the processing partition 211 responsive to determining the processing partition 211 satisfies an available resource criterion. The available resource criterion may specify a threshold level of resource availability, such as a threshold percentage of available CPU resources, processing capability, or any other measure of computing capacity. In that regard, the management engine 110 may leverage both (i) data locality to support local memory access to data partition A as well as (ii) capacity of the processing partition 211 for immediate execution of the task.

Responsive to a determination that the processing partition 211 fails to satisfy an available resource criterion, the management engine 110 may schedule the task (operating on data partition A) in various ways. As one example, the management engine 110 may schedule the task for execution by the processing partition 211 at a subsequent time when the processing partition 211 satisfies the available resource criterion. In such examples, the management engine 110 may, in effect, wait until the processing partition 211 frees up resources to execute the task. As another example, the management engine 110 may schedule the task for immediate execution by another processing partition on a different node. For instance, the management engine 110 may schedule the task for execution by the processing partition 212 or 213 located on different NUMA nodes, even though such task scheduling may require a remote data access to retrieve data partition A to operate on.

As another example when the processing partition 211 fails to satisfy an available resource criterion, the management engine 110 may apply a timeout period. In doing so, the management engine 110 may schedule the task for execution on the processing partition 211 if the processing partition 211 satisfies an available resource criterion within the timeout period. If not and the timeout period lapses, the management engine 110 may schedule the task for immediate execution by another processing partition located on a different NUMA node.

As yet another example, the management engine 110 may perform any number of work flow estimations and adaptively schedule the task for execution by the processing partition 211 or another processing partition located on a remote NUMA node based on estimation comparisons. To illustrate, the management engine 110 may identify the number tasks currently executing or queued for each of the processing partitions 211, 212, and 213. Doing so may allow the management engine 110 to estimate a time at which resources become available on the processing partitions 211, 212, and 213 to execute the task upon data partition A. The management engine 110 may account for execution time of the task on processing partition 211 (with local memory access to data partition A) as well as 212 and 213 (with remote memory access to data partition A). Accounting for the workflow timing of the various processing partitions and execution timing of the task, the management engine 110 may schedule the task for execution by the processing partition that would result in the task completing execution at the earliest time. As such, the management engine 110 may adaptively schedule tasks based on node identifiers specified in partition metadata.

Some examples of node-based scheduling were described above. The management engine 110 may implement any combination of the scheduling features described above for NUMA-based task scheduling, physical device-based task scheduling, or at other granularities. The management engine 110 may apply node-based scheduling because partition metadata stored on the metadata store 112 includes node identifiers. Doing so may allow the management engine 110 to account for data locality in task scheduling, and task execution may occur with increased efficiency.

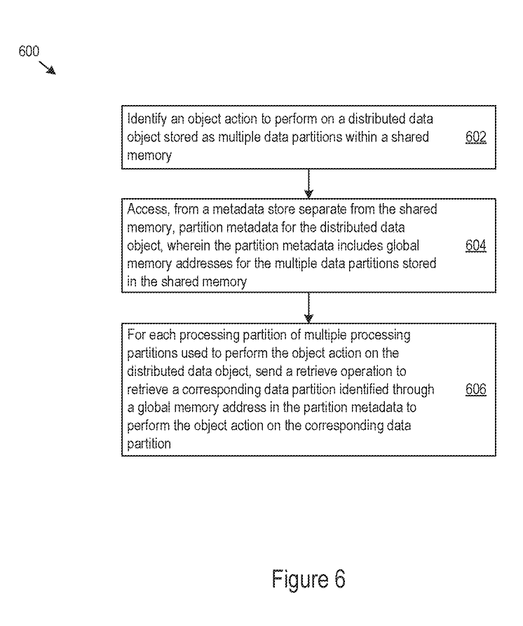

FIG. 6 shows a flow chart of an example method 600 to use partition metadata for a distributed data object. Execution of the method 600 is described with reference to the management engine 110, though any other device, hardware-programming combination, or other suitable computing system may execute any of the steps of the method 600. As examples, the method 600 may be implemented in the form of executable instructions stored on a machine-readable storage medium or in the form of electronic circuitry.

In implementing or performing the method 600, the management engine 110 may identify an object action to perform on a distributed data object stored as multiple data partitions within a shared memory (602). The management engine 110 may also access, from a metadata store separate from the shared memory, partition metadata for the distributed data object, wherein the partition metadata includes global memory addresses for the multiple data partitions stored in the shared memory. For each processing partition of multiple processing partitions used to perform the object action on the distributed data object, the management engine 110 may send a retrieve operation to retrieve a corresponding data partition identified through a global memory address in the partition metadata to perform the object action on the corresponding data partition (606).

As noted above, the management engine 110 may apply node-based task scheduling techniques, any of which may be implemented or performed as part of the method 600. In some examples, the partition metadata may further include node identifiers for the multiple data partitions. In such examples, the management engine 110 may identify a task that is part of the object action, determine a particular data partition that the task operates on, determine, according to the node identifiers of the partition metadata, a particular node that the particular data partition is stored on, and schedule the task for execution by a processing partition located on the particular node. In particular, the node identifiers may specify a particular NUMA node, in which case the management engine 110 may determine a particular NUMA node that the particular data partition is stored on and schedule the task for execution by a processing partition located on the particular NUMA node.

In some node-based scheduling examples, the management engine 110 may schedule a task for immediate execution by a processing partition responsive to determining the processing partition satisfies an available resource criterion. As another example, the management engine 110 may schedule a task by determining the processing partition fails to satisfy an available resource criterion for executing the task. In response, the management engine 110 may schedule the task for execution by the processing partition at a subsequent time when the processing partition satisfies the available resource criterion.

Prior to accessing the partition metadata, the management engine 110 may send partition store instructions to store the multiple data partitions that form the distributed data object within the shared memory. The management engine 110 may also obtain the partition metadata for the distributed data object from multiple processing partitions that stored the multiple data partitions in the shared memory and store the partition metadata in the metadata store.

Although one example was shown in FIG. 6, the steps of the method 600 may be ordered in various ways. Likewise, the method 600 may include any number of additional or alternative steps, including steps implementing any of the features described herein. As examples, the method 600 may implement features with respect to the management engine 110 or processing partitions for storing multiple data partitions to cache a distributed data object, retrieving data partitions to support parallel processing operations executed upon the distributed data object, node-based task scheduling of operations on the multiple data partitions, and more.

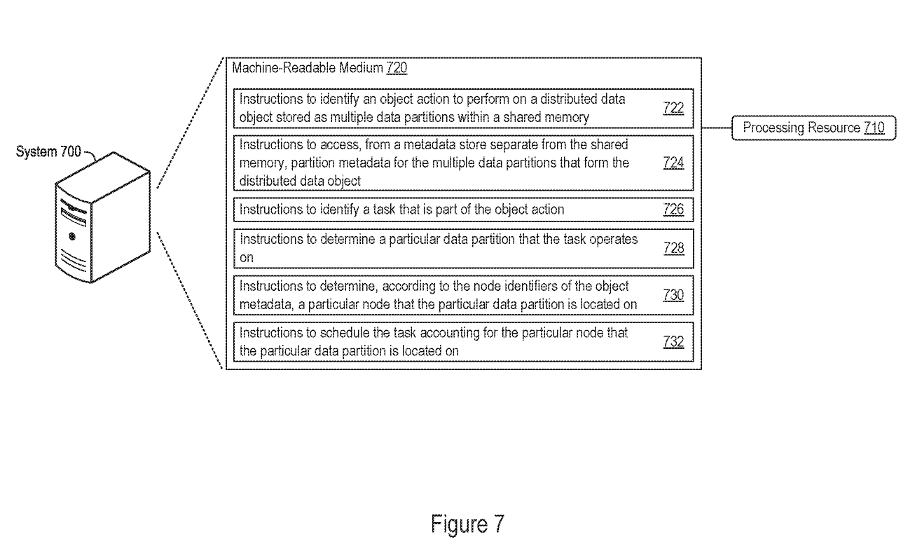

FIG. 7 shows an example of a system 700 that supports scheduling tasks for execution using partition metadata for a distributed data object. The system 700 may include a processing resource 710, which may take the form of a single or multiple processors. The processor(s) may include a central processing unit (CPU), microprocessor, or any hardware device suitable for executing instructions stored on a machine-readable medium, such as the machine-readable medium 720 shown in FIG. 7. The machine-readable medium 720 may be any non-transitory electronic, magnetic, optical, or other physical storage device that stores executable instructions, such as the instructions 722, 724, 726, 728, 730, and 732 shown in FIG. 7. As such, the machine-readable medium 720 may be, for example, Random Access Memory (RAM) such as dynamic RAM (DRAM), flash memory, memristor memory, spin-transfer torque memory, an Electrically-Erasable Programmable Read-Only Memory (EEPROM), a storage drive, an optical disk, and the like.

The system 700 may execute instructions stored on the machine-readable medium 720 through the processing resource 710. Executing the instructions may cause the system 700 to perform any of the features described herein, including according to any features of the management engine 110 or processing partitions described above.

For example, execution of the instructions 722 and 724 by the processing resource 710 may cause the system 700 to identify an object action to perform on a distributed data object stored as multiple data partitions within a shared memory (instructions 722); access, from a metadata store separate from the shared memory, partition metadata for the multiple data partitions that form the distributed data object (instructions 724). The partition metadata may include global memory addresses for the multiple data partitions and node identifiers specifying particular nodes that the multiple data partitions are stored on. Execution of the instructions 726, 728, 730, and 732 by the processing resource 710 may cause the system 700 to identify a task that is part of the object action (instructions 726); determine a particular data partition that the task operates on (instructions 728); determine, according to the node identifiers of the partition metadata, a particular node that the particular data partition is stored on (instructions 730); and schedule the task accounting for the particular node that the particular data partition is stored on (instructions 732).

In some examples, the instructions 732 may be executable by the processing resource 710 to schedule the task accounting for the particular node that the particular data partition is stored on by scheduling the task for immediate execution by a processing partition also located on the particular node responsive to determining the processing partition satisfies an available resource criterion. As noted above, immediate execution may refer to scheduling the task for execution by the processing resource without introducing an intentional or unnecessary delay as part of the scheduling process. As another example, the instructions 732 may be executable by the processing resource 710 to schedule the task accounting for the particular node that the particular data partition is stored on by determining that a processing partition located on the particular node fails to satisfy an available resource criterion for executing the task and scheduling the task for execution by the processing partition at a subsequent time when the processing partition satisfies the available resource criterion. As yet another example, the instructions 732 may be executable by the processing resource 710 to schedule the task accounting for the particular node that the particular data partition is stored on by determining that a processing partition located on the particular node fails to satisfy an available resource criterion for executing the task and scheduling the task for immediate execution by another processing partition on a different node. The instructions 732 may implement any combination of these example features and more in scheduling the task for execution.

In some examples, the non-transitory machine-readable medium 720 may further include instructions executable by the processing resource 710 to, prior to access of the partition metadata send partition store instructions to store, within the shared memory, the multiple data partitions that form the distributed data object; obtain the partition metadata for the distributed data object from multiple processing partitions that stored the multiple data partitions in the shared memory; and store the partition metadata in the metadata store. In such examples, the instructions may be executable by the processing resource 710 to store, as part of the partition metadata, attribute metadata tables for the distributed data object, wherein each particular attribute metadata table includes global memory addresses for particular data partitions storing object data for a specific attribute of the distributed data object.

The systems, methods, devices, engines, architectures, memory systems, and logic described above, including the management engine 110, may be implemented in many different ways in many different combinations of hardware, logic, circuitry, and executable instructions stored on a machine-readable medium. For example, the management engine 110 may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above, including according to any features of the management engine 110, processing partitions, metadata store, shared memory, and more.

The processing capability of the systems, devices, and engines described herein, including the management engine 110, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A system comprising:
a shared memory;
a metadata store separate from the shared memory; and
a management engine to:
receive input data;
partition the input data into multiple data partitions to cache the input data in the shared memory as a distributed data object;
send partition store instructions to store the multiple data partitions within the shared memory;
obtain partition metadata for the multiple data partitions that form the distributed data object_{;} wherein the partition metadata includes global memory addresses within the shared memory for the multiple data partitions; and
store the partition metadata in the metadata store.

2. The system of claim 1, wherein management engine is to:
send a first store partition instruction to a processing partition of multiple processing partitions instantiated to cache the input data as a distributed data object; and
obtain, as part of the partition metadata, first partition metadata for a first data partition stored in the shared memory by the first processing partition.

3. The system of claim 2, wherein the management engine is further to broadcast the first partition metadata to other processing partitions that stored other data partitions of the input data.

4. The system of claim 1, wherein the management engine is to store, as part of the partition metadata, attribute metadata tables for the distributed data object, wherein each particular attribute metadata table includes global memory addresses for particular data partitions storing object data for a specific attribute of the distributed data object.

5. The system of claim 1, wherein the partition metadata further includes node identifiers for the multiple data partitions.

6. The system of claim 5, wherein a node identifier for a particular data partition specifies a particular non-uniform memory access (NUMA) node that the particular data partition is stored on.

7. The system of claim 5, wherein the management engine is further to:
identify a task to perform on a particular data partition of the distributed data object;
determine, according to the node identifiers of the partition metadata, a particular node that the particular data partition is stored on; and
schedule the task for execution by a processing partition also located on the particular node.

8. A method comprising:
identifying an object action to perform on a distributed data object stored as multiple data partitions within a shared memory;
accessing, from a metadata store separate from the shared memory, partition metadata for the distributed data object, wherein the partition metadata includes global memory addresses for the multiple data partitions stored in the shared memory; and
for each processing partition of multiple processing partitions used to perform the object action on the distributed data object:
sending a retrieve operation to retrieve a corresponding data partition identified through a global memory address in the partition metadata to perform the object action on the corresponding data partition.

9. The method of claim 8, wherein the partition metadata further includes node identifiers for the multiple data partitions, and further comprising:
identifying a task that is part of the object action;
determining a particular data partition that the task operates on;
determining, according to the node identifiers of the partition metadata, a particular node that the particular data partition is stored on; and
scheduling the task for execution by a processing partition located on the particular node.

10. The method of claim 9, wherein the node identifiers specify a particular non-uniform memory access (NUMA) node, and comprising:
determining a particular NUMA node that the particular data partition is stored on; and
scheduling the task for execution by a processing partition located on the particular NUMA node.

11. The method of claim 9, wherein scheduling the task comprises scheduling the task for immediate execution by the processing partition responsive to determining the processing partition satisfies an available resource criterion.

12. The method of claim 9, wherein scheduling the task comprises:
determining the processing partition fails to satisfy an available resource criterion for executing the task; and
scheduling the task for execution by the processing partition at a subsequent time when the processing partition satisfies the available resource criterion.

13. The method of claim 8, further comprising, prior to accessing the partition metadata:
sending partition store instructions to store, within the shared memory, the multiple data partitions that form the distributed data object;
obtaining the partition metadata for the distributed data object from multiple processing partitions that stored the multiple data partitions in the shared memory; and
storing the partition metadata in the metadata store.

14. The method of claim 13, comprising storing, as part of the partition metadata, attribute metadata tables for the distributed data object, wherein each particular attribute metadata table includes global memory addresses for particular data partitions storing object data for a specific attribute of the distributed data object.

15. A non-transitory machine-readable medium comprising instructions executable by a processing resource to:
identify an object action to perform on a distributed data object stored as multiple data partitions within a shared memory;
access, from a metadata store separate from the shared memory, partition metadata for the multiple data partitions that form the distributed data object, wherein the partition metadata includes:
global memory addresses for the multiple data partitions; and
node identifiers specifying particular nodes that the multiple data partitions are stored on;
identify a task that is part of the object action;
determine a particular data partition that the task operates on;
determine, according to the node identifiers of the partition metadata, a particular node that the particular data partition is stored on; and
schedule the task accounting for the particular node that the particular data partition is stored on.

16. The non-transitory machine-readable medium of claim 15, wherein the instructions are executable by the processing resource to schedule the task accounting for the particular node that the particular data partition is stored on by:
scheduling the task for immediate execution by a processing partition also located on the particular node responsive to determining the processing partition satisfies an available resource criterion.

17. The non-transitory machine-readable medium of claim 15, wherein the instructions are executable by the processing resource to schedule the task accounting for the particular node that the particular data partition is stored on by:
determining that a processing partition located on the particular node fails to satisfy an available resource criterion for executing the task; and
scheduling the task for execution by the processing partition at a subsequent time when the processing partition satisfies the available resource criterion.

18. The non-transitory machine-readable medium of claim 15, wherein the instructions are executable by the processing resource to schedule the task accounting for the particular node that the particular data partition is stored on by:
determining that a processing partition located on the particular node fails to satisfy an available resource criterion for executing the task; and
scheduling the task for immediate execution by another processing partition on a different node.

19. The non-transitory machine-readable medium of claim 15, wherein the non-transitory machine-readable medium further comprises instructions executable by the processing resource to, prior to access of the partition metadata:
send partition store instructions to store, within the shared memory, the multiple data partitions that form the distributed data object;
obtain the partition metadata for the distributed data object from multiple processing partitions that stored the multiple data partitions in the shared memory; and
store the partition metadata in the metadata store.

20. The non-transitory machine-readable medium of claim 15, wherein the instructions are executable by the processing resource to store, as part of the partition metadata, attribute metadata tables for the distributed data object, wherein each particular attribute metadata table includes global memory addresses for particular data partitions storing object data for a specific attribute of the distributed data object.
